(19) United States
(12) Patent Application Publication
(10) Pub. No.: US 2024/0183385 A1
(43) Pub. Date: Jun. 6, 2024

(54) MODULAR RADIAL FOIL BEARING WITH OUTER SLEEVE

(71) Applicant: Schaeffler Technologies AG & Co. KG, Herzogenaurach (DE)

(72) Inventors: Jürgen Hilbinger, Neustadt/A. (DE); Andre Anger, Uehlfeld (DE); Hermann Geyer, Vestenbergsgreuth (DE); Sven Lautner, Herzogenaurach (DE)

(73) Assignee: Schaeffler Technologies AG & Co. KG, Herzogenaurach (DE)

(21) Appl. No.: 18/285,851

(22) PCT Filed: Mar. 29, 2022
(86) PCT No.: PCT/DE2022/100244

§ 371 Date: Oct. 5, 2023

(30) Foreign Application Priority Data
Apr. 9, 2021 (DE) 10 2021 108 889.5

(51) Int. Cl. F16C 17/02

(52) U.S. Cl. CPC F16C 17/024; F16C 2300/22

(57) ABSTRACT

A radial foil bearing includes a base foil, a first top foil, a first corrugated foil, a second top foil and a second corrugated foil. The first corrugated foil is arranged radially on top of the first top foil and fixed to the first top foil to form a first curved segment fixed to the base foil and extending in a circumferential direction. The second corrugated foil is arranged radially on top of the second top foil and fixed to the second top foil to form a second curved segment fixed to the base foil and extending in the circumferential direction. The second curved segment is placed after the first curved segment on the base foil so that, when the base foil is rolled up, the first curved segment and the second curved segment form at least a portion of a tubular base.

### CROSS-REFERENCE TO RELATED APPLICATIONS

This application is the United States National Phase of PCT Appln. No. PCT/DE2022/100244 filed Mar. 29, 2022, which claims priority to German Application No. DE102021108889.5 filed Apr. 9, 2021, the entire disclosures of which are incorporated by reference herein.

### TECHNICAL FIELD

The disclosure relates to a foil bearing and, more specifically, to a modular radial foil bearing with an outer sleeve.

### BACKGROUND

Radial foil bearings are intended for the aerodynamic mounting of shafts, wherein a load-bearing gas/air cushion is formed between the shaft and the radial foil bearing. The mode of operation is similar to that of a hydrodynamic plain bearing, but with the difference that the shaft is supported by the radial foil bearing via an air cushion and not by a fluid cushion of a hydrodynamic plain bearing. Both functional forms have in common that only the rotational motion of the shaft leads to the formation of the load-bearing cushion.

Foil bearings differ from conventional aerodynamic bearings in that they have a flexible, elastic structure between the rotating shaft and the stationary housing component. This feature means that although they exhibit a lower rigidity than conventional air bearings, they can adapt to geometric changes in the air gap caused, for example, by misalignment errors of the bearing seats or differing thermal expansion of the shaft and housing, thus enabling higher operational reliability in practice in many applications.

To form the load-bearing air cushion, the radial foil bearing usually has a top foil in contact with the stationary shaft and a corrugated foil disposed radially between the top foil and the outer ring of the bearing, which can elastically deflect in the radial direction. Thus, in principle, the radial foil bearing has two foils in contact with one another and an outer ring supporting the foils so that the radial foil bearing can be received in a housing. The outer ring can also be formed integrally with the housing, in which the foils of the radial foil bearing are inserted.

If the shaft is set in rotational motion relative to the radial foil bearing, the air present in the air gap defined by the standstill is displaced. Above a certain speed of the shaft, an air cushion forms between the top foil and the shaft on which the shaft can slide. In this regard, the foil package with the corrugated foil and radial spring effect thereof ensures that fluctuations in air pressure or vibrations of the shaft in the radial direction do not affect the bearing and thus keep the air cushion load-bearing.

In the prior art, a variety of designs of foil bearings are known. In addition to radial foil bearings, there are also axial foil bearings that can provide an axial load-bearing capacity. The arrangement of the foils of the bearing as well as their geometric design are diverse and adapted to each application.

EP 2 942 537 A1 shows a radial foil bearing having three corrugated foils and an almost circumferential top foil, wherein the corrugated foils are each hooked with a hook-shaped end into their own slot in the outer ring and the top foil is inserted into one of the slots with both ends resting against one another.

EP 3 387 275 A1 shows a radial foil bearing with three packs consisting of top foil and corrugated foil, wherein each pack is inserted into a slot in the outer ring at each end of the foils.

CN 209990776 U shows a radial foil bearing in which both the corrugated foil and the top foil are designed to be almost completely circumferential, and each have an angled end with which both foils are inserted into a common slot. This connection is then secured with a screw in a clamping manner.

EP 2 473 749 A1 shows a radial foil bearing with precisely one top foil and precisely one corrugated foil for forming the bearing in an outer ring.

It has proven problematic to arrange the foils economically to optimize the functional load-bearing capacity.

### SUMMARY

The present disclosure provides a radial foil bearing which permits an economical arrangement of the foils and improves the radial foil bearing with regard to the function thereof.

The present disclosure provides a radial foil bearing that has a first curved segment, consisting of a first top foil and a first corrugated foil, which are firmly connected to one another at a common end with the first curved segment firmly disposed on a base foil, and a second curved segment consisting of a second top foil and a second corrugated foil, which are firmly connected to one another at a common end, that is disposed on the base foil. The two curved segments are placed one after the other on this base foil so that when the base foil is rolled up, a tubular base with the two curved segments arises and forms the radial foil bearing.

The base foil may be formed from a thin (<0.5 mm) sheet metal strip made of stainless spring steel sheet metal, which can be bent into a circular shape by hand or using an auxiliary device.

The curved segments are formed from a top foil and a corrugated foil, which are firmly connected to one another at one end, e.g., welded. The curved segments are then placed on the base foil in sequence, and the two consecutive curved segments are spaced apart from one another such that after the base foil has been rolled up to form the tubular base, one end of a curved segment will either slightly overlap, abut, or be spaced apart from the subsequent end of the subsequent curved segment.

In this case, the base foil is wrapped around the curved segments, so that the base foil has wrapped and surrounds the curved segments. Thus, in the radial direction, the foils from the top foil and corrugated foil that rest against one another are followed by the base foil after the formation of the tubular base.

The curved segments are directly and/or indirectly fixed at one end to the base foil, for example welded.

To reliably place and attach a curved segment to the base foil with the end at which the two foils are connected to one another, the base foil has positioning means, for example in the form of a recess, which can be brought into contact or alignment with this end of the curved segment. The positioning means may be designed as a notch on the edge of the strip-shaped base foil and is therefore easily accessible for a tool that aligns the curved segment with this positioning means.

Here, a radial foil bearing can be used as an assembly of curved segments and base foil directly in a bearing receiving bore, for example a compressor housing, or as a self-retaining unit of curved segments and base foil connected to a bearing outer ring sleeve, which can then be installed in the assembly.

Thus, the radial foil bearing according to the disclosure can be used for oil-free and high-speed rotor bearings, for example in fuel cell compressors, eBoosters or turbochargers. The design of the radial foil bearing according to the disclosure enables cost-efficient large-scale production and provides an option for a modular design to cover the different requirements in terms of the implementation of the radial foil bearing in the component assembly.

In an example embodiment, a third curved segment is formed with a third top foil and a third corrugated foil. Three curved segments, each consisting of a top foil and a corrugated foil, are disposed one after the other on the base foil so that when the base foil is rolled up, the tubular base is created from the three curved segments and forms the radial foil bearing. The use of three curved segments better centers the shaft during operation.

The number of curved segments and their sequential arrangement on a base foil can be scaled or multiplied, i.e., several curved segments or groups of curved segments can be provided, which are firmly placed consecutively on the base foil so that when the base foil is rolled up, the tubular base with the curved segments is created and the radial foil bearing is formed.

In an example embodiment, after the base foil has been rolled up to form a tubular base with the curved segments, the tubular base has a peripheral (closed) shape, and the two ends of the base foil face one another. The opposite ends of the base foil can
contact each other with their faces or
form an overlap in the radial direction or
have a small spacing apart from their end faces with respect to each other.

In cases where the ends of the base foil contact or overlap, these ends can be firmly connected to one another in a closed form of the annular base. If the closed annular base is present with firmly connected ends, it can either be inserted into an outer ring or directly into a housing bore. If the ends of the annular base are not firmly connected to one another, an assembly or installation aid is required to insert the tubular base into an outer ring or directly into a housing bore.

The circumferential length of the base foil corresponds to at least 2400 of the inner circumference of the receiving bore for the tubular base. The base foil hugs the circular shape of the inner peripheral surface of the bearing seat bore/bearing outer ring sleeve after the tubular base has been inserted and is therefore designed to fit.

In an example embodiment, after the base foil has been rolled up to form a tubular base with the curved segments, one end of one curved segment is opposite the end of a subsequent curved segment and the opposite ends contact each other. Alternatively, the opposite ends are spaced apart from one another. Two curved segments can also overlap. It is also possible for only one of the foils of the one curved segment to overlap with one of the foils of the other curved segment, so that these overlapping foils contact one another in the radial direction in the area of the overlap. The radial foil bearing or the tubular base can thus be designed to be more stable and more efficient.

The foils of a curved segment can overlap with the foils of a subsequent curved segment after the tubular base has been formed in such a way that the functionally required wedge gap towards the rotating shaft is formed to form the supporting air cushion. The disclosure provides that the annular base is inserted into an outer ring to form the radial foil bearing.

In this case, the outer ring can be a separate component which, together with the tubular base, forms the radial foil bearing, which is then inserted into a housing. As an alternative thereto, the outer ring can be formed by the housing itself, as a result of which the tubular base can be used to form the radial foil bearing.

At least the one degree of freedom in an axial direction of the tubular base placed in the outer ring is blocked. Both degrees of freedom may be blocked in both axial directions of the tubular base placed in the outer ring.

The disclosure provides that a degree of freedom in the circumferential direction of the tubular base, which is placed in the outer ring, is blocked. Thus, the tubular base, which is inserted into the outer ring, can be welded thereto so that a relative rotation between the tubular base and the outer ring is prevented.

### BRIEF DESCRIPTION OF THE DRAWINGS

Example embodiments of the disclosure are shown in the following figures. In the figures:

FIG. 1 shows a base foil having three curved segments attached thereto,

FIG. 2 shows a curved segment with a top foil and a corrugated foil in the state of being connected to one another,

FIG. 3 shows a curved segment with a top foil and a corrugated foil in the separated state,

FIG. 4 shows a radial foil bearing according to the disclosure,

FIG. 5 shows an outer ring for receiving a tubular base,

FIG. 6 shows the outer ring according to FIG. 5 with the mounted tubular base,

FIG. 7 shows a section in the axial direction through the embodiment according to FIG. 6,

FIG. 8 shows one axial end of the sectioned outer ring according to FIG. 7,

FIG. 9 shows the other axial end of the sectioned outer ring according to FIG. 7,

FIG. 10 shows a second variant of the outer ring with a mounted tubular base,

FIG. 11 shows the outer ring for receiving a tubular base according to FIG. 10,

FIG. 12 shows a section in the axial direction through the embodiment according to FIG. 10,

FIG. 13a shows a detailed view of one axial end of the sectioned outer ring according to FIG. 12,

FIG. 14 shows a detailed view of the other axial end of the sectioned outer ring according to FIG. 12,

FIG. 15 shows a third variant of the outer ring having a mounted tubular base,

FIG. 16 shows a detailed view of the radial foil bearing according to FIG. 15,

FIG. 17 shows a section in the axial direction through the embodiment according to FIG. 15,

FIG. 18 shows a detailed view of one axial end of the sectioned outer ring according to FIG. 15, and

FIG. 19 shows a detailed view of the other axial end of the sectioned outer ring according to FIG. 15.

### DETAILED DESCRIPTION

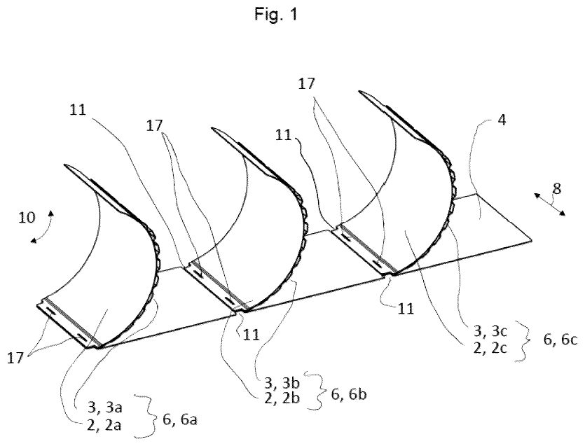

FIG. 1 shows a base foil 4 having three curved segments 6a, 6b, 6c attached thereto. The base foil 4 is designed as a strip of material, e.g., as a sheet metal strip, which has a maximum thickness of 0.5 mm. The strip-shaped base foil 4 extends transversely in the subsequent axial direction 8, which is defined after the base foil 4 has been rolled up to form a tubular base. The base foil 4 has several recesses, e.g., in the form of a notch 11, with which an alignment of the curved segments 6 to be placed on the base foil 4 is to take place so that the curved segments 6 to be placed can easily and reliably be disposed at the correct distances from one another on the base foil 4, and then can be attached to the base foil 4.

In FIG. 1, three curved segments 6a, 6b, 6c are disposed sequentially and in a pattern on a base foil 4, so that the present pattern is largely regular and repeatable and all curved segments 6a, 6b, 6c have the same orientation on the base foil 4. Each curved segment 6a, 6b, 6c has an end with which both the respective curved segment 6 on the base foil 4 and the foils 2 and 3 of the curved segment 6 are welded to one another. This welding 17 of all components can be done together when positioning the foils 2 and 3 to form a curved segment 6 on the base foil 4, or the curved segment 6 can be designed as a pre-assembled foil package consisting of a top foil and a corrugated foil 2 and 3 already present with the base foil 4.

For the precise positioning of the curved segments 6a, 6b, 6c on the base foil 4, the curved segments 6a, 6b, 6c are each brought into congruence with a notch 11 in such a way that, for example, the end edge of a curved segment 6 is aligned with an edge of the notch 11. The notches 11 may be formed for a curved segment 6 on the opposite edges delimiting the strip-shaped base foil 4 and are present in pairs for a curved segment 6. The shape and position of such notches 11 as positioning means can vary; alternatively, such a positioning means can also be disposed within the strip-shaped base foil 4 and have a shape that is favorable for positioning a curved segment 6.

As can be seen from FIG. 1, the curved segments 6a, 6b, 6c are already bent when they are mounted on the flat, strip-shaped base foil 4.

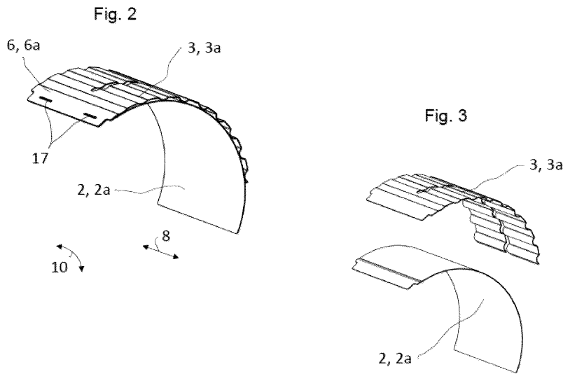

FIG. 2 shows a curved segment 6 or 6a with a top foil and a corrugated foil 2 and 3 or 2a and 3a in the connected state. A top foil 2 and a corrugated foil 3 are used for a curved segment 6, which are brought into alignment at a common end and are connected to one another. The respective other end of the curved segment 6 allows the two foils 2 and 3 to move freely with respect to one another. The design of the curved segment 6 already defines an axial direction 8 and a circumferential direction 10, which is transferred to the other assemblies.

FIG. 3 shows a curved segment 6a having a top foil and a corrugated foil 2a and 3a in the separated state. The foils 2 and 3 to be joined together are ideally already bent. The curved shape is such that the top foil 2—contrary to the illustration in FIG. 3—can be brought to the inner lateral surface of the corrugated foil 3, wherein the curved appearance of both foils 2 and 3 is congruent.

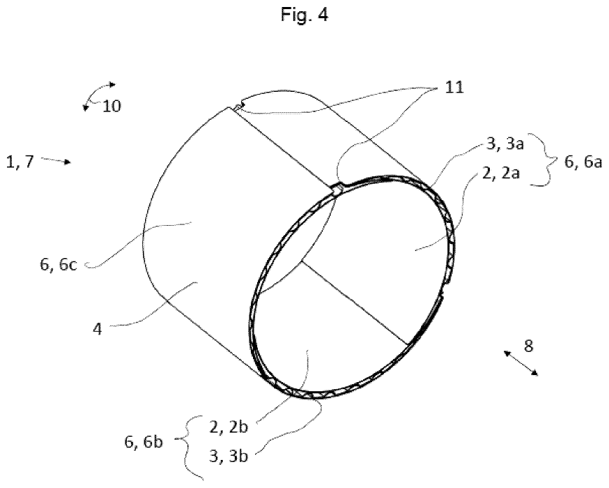

FIG. 4 shows a radial foil bearing 1 according to the disclosure. The radial foil bearing 1 is produced by rolling up the base foil 4 in the circumferential direction 10. The prepared formation of the base foil 4 with the curved segments 6a, 6b, 6c is present, for example according to FIG. 1. The radial foil bearing 1 is already present as a tubular base 7 in FIG. 4, and can be inserted into a receiving bore of a housing of an assembly adapted to the base 7 and operated there to support a shaft.

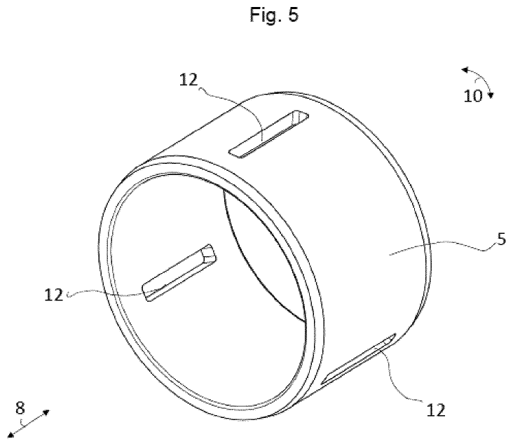

FIG. 5 shows an outer ring 5 for receiving a tubular base 7. The radial foil bearing 1 according to FIG. 4 in the form of the tubular base 7 can be upgraded by inserting it into an outer ring 5, wherein the sensitive foils 2, 3, and 4 are protected from external influences by the outer ring 5. The outer ring 5 may be designed as a deep-drawn sheet metal sleeve and, according to FIG. 5, provided with slots 12 distributed regularly in the circumferential direction 10. These slots 12 can easily be punched in a sheet metal sleeve and are provided for the accessibility of a tool for the tubular base 7.

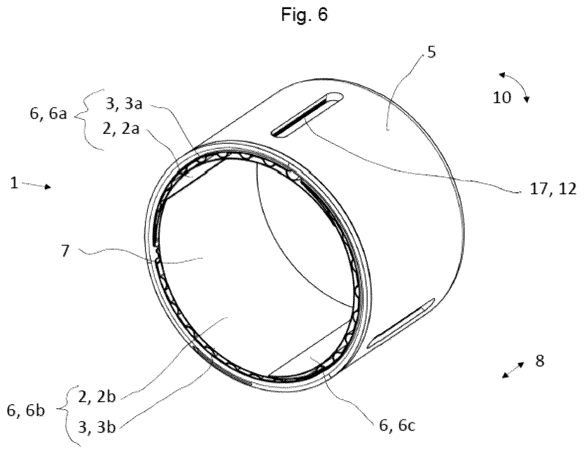

FIG. 6 shows the outer ring 5 according to FIG. 5 with the tubular base 7 mounted. The tubular base 7, for example according to FIG. 4, has been inserted into the outer ring 5 according to FIG. 5. The axial length of the tubular base 7 corresponds to the axial length of the outer ring 5, after which the base 7 is flush with the outer ring 5 at both axial ends. As an alternative thereto, a slight overhang may be provided in the sense that the axial length of the outer ring 5 is greater than the axial length of the base 7, so that the edges of the foils 2, 3 and 4 are better protected from impact points.

The slots 12 ensure the accessibility of a tool which can firmly connect, e.g., weld, the base 7 to the outer ring 5, and the outer peripheral surface of the base foil 4 lies against the inner peripheral surface of the outer ring 5.

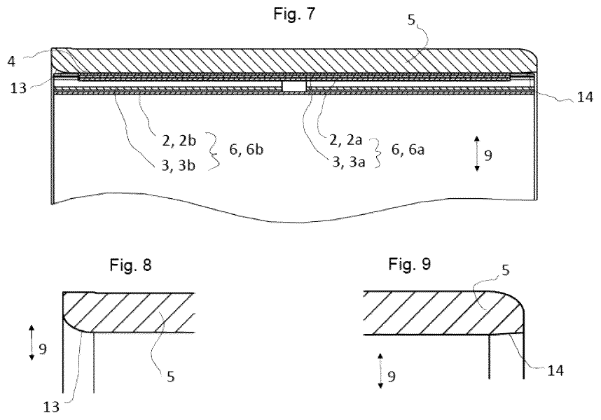

FIG. 7 shows a section in the axial direction 8 through the embodiment of FIG. 6. In this exemplary embodiment, the axial length of the base 7 and thus also the axial length of the curved segments 6a, 6b, 6c, and the base foil 4 corresponds to the axial length of the outer ring 5. It can now be seen that, in the radial direction 9, the foils 2a, 2b, 3a, and 3b are stacked on top of one another. This is due to the fact that the curved segments 6a and 6b cover or overlap to a small extent in the circumferential direction 10. This overlap takes place in the area of the weld 17, and a fixed (welded) end of a curved segment 6a with the base foil 4 covers a loose end of the curved segment 6b following the curved segment 6a, so that in the sectional view the foils 2a, 2b, 3a, and 3b appear stacked in the radial direction. FIG. 8 shows one axial end of the sectioned outer ring 5 according to FIG. 7. One axial end has a rounding 13 on the radial inside of the outer ring 5, which is intended to facilitate the insertion of the base 7 into the outer ring 5.

FIG. 9 shows the other axial end of the sectioned outer ring 5 according to FIG. 7. This axial end has a chamfer 14 on the radial inside of the outer ring 5, which is provided to prevent damage to the foils 2, 3, and 4 when handling the radial foil bearing 1 or when transporting the radial foil bearing 1.

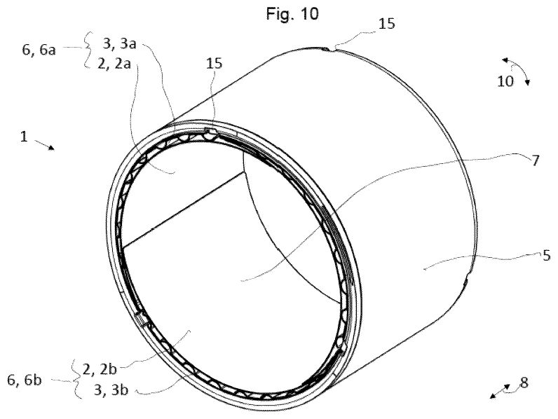

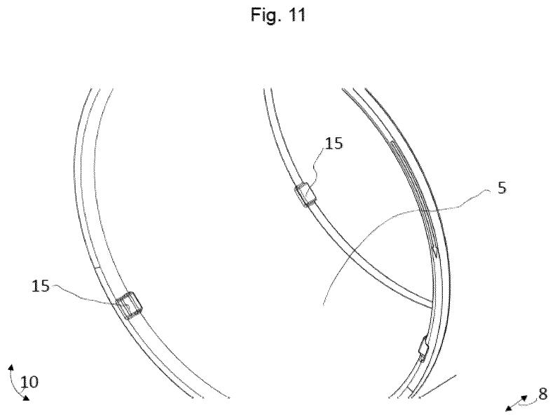

FIG. 10 shows a second variant of the outer ring 5 with the mounted tubular base 7. This outer ring 5 no longer has slits 12, but instead several material displacements 15, which are better illustrated in FIG. 11.

FIG. 11 shows the outer ring 5 for receiving a tubular base 7 according to FIG. 10. At the axial end thereof, the outer ring 5 has material displacements 15 which lie opposite one another in the axial direction 8, and which have been formed from the material of the outer ring 5. These material displacements 15, which protrude radially inwards, fit into the notches 11, which are designed as positioning means, in the base foil 4 or the tubular base 7.

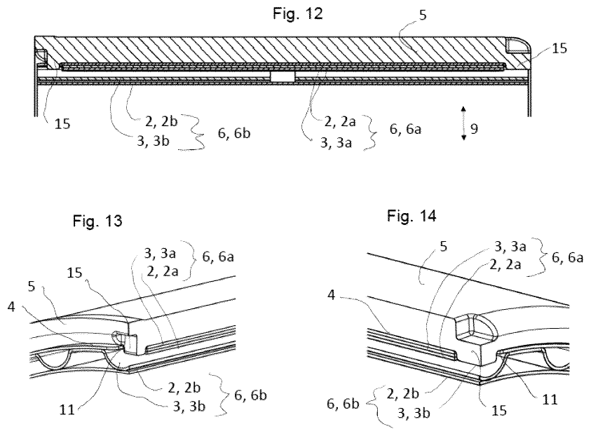

FIG. 12 shows a section in the axial direction 8 through the embodiment of FIG. 10. In addition to the curves 13 and chamfers 14 of the outer ring 5 according to FIG. 7, the outer ring 5 can have these local and discrete material displacements 15. The overlapping of two curved segments 6a and 6b or the foils 2a, 2b, 3a, and 3b thereof, which have already been adequately described in FIG. 7, is clearly visible in FIG. 12.

FIG. 13 shows a detailed view of one axial end of the sectioned outer ring 5 according to FIG. 12. The material displacement 15 directed radially inwards is formed by displacement of material of the outer ring 5 in the axial direction at a specific position which engages in a notch 11 of the base foil 4 to secure the position of the tubular base 7 in the circumferential direction 10 and in the axial direction 8. At least one degree of freedom of the tubular base 7 relative to the outer ring 5 is blocked here.

FIG. 14 shows a detailed view of the other axial end of the sectioned outer ring 5 according to FIG. 12. At the (other) end of the outer ring 5 opposite the one axial end of the outer ring 5 according to FIG. 13 in the axial direction 8, the material of the outer ring 5 is displaced inward in the radial direction and forms a material displacement 15 directed radially inward on this axial side of the outer ring 5, which also engages in a notch 11 of the base foil 4 to additionally secure the position of the tubular base 7 in the circumferential direction 10 and in the axial direction 8 and to block further degrees of freedom of the tubular base 7 in relation to the outer ring 5.

As an alternative to the embodiment according to FIG. 12, it is also conceivable that either the embodiment of the material displacement 15 according to FIG. 13 or the embodiment of the material displacement 15 according to FIG. 14 is disposed on both axial ends of the outer ring 5.

The material displacements 15 may have already been introduced before the assembly of the outer ring 5 with the tubular base 7, so as not to damage the foil packages of the curved segments 6a, 6b, 6c during the displacement process. The tubular base 7 is so flexible in the shape thereof that it can be inserted into the outer ring 5 without any problems.

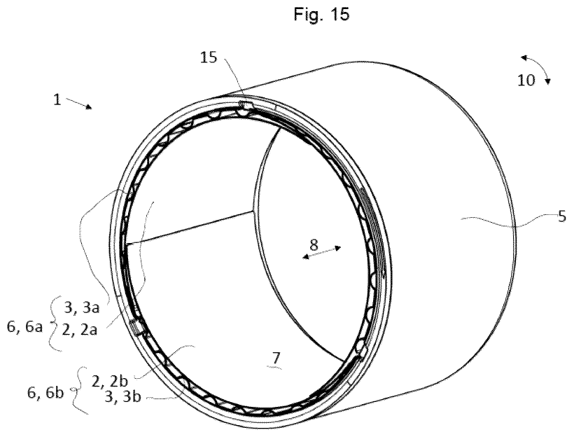

FIG. 15 shows a third variant of the outer ring 5 having a mounted tubular base 7. In contrast to the outer rings 5 of FIGS. 5 and 10, this outer ring 5 has a material displacement 15 at the one axial end thereof, while an annular collar 16 formed by the outer ring 5 is disposed at the other axial end thereof.

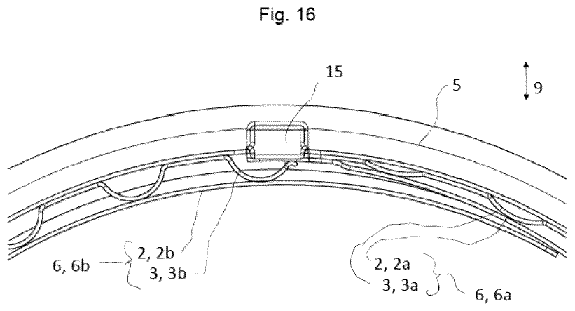

FIG. 16 shows a detailed view of the radial foil bearing 1 according to FIG. 15. The rectangular material displacement 15 is clearly visible, which is formed by axially pushing a tool into the material of the outer ring 5 in such a way that a material displacement 15 directed radially inwards is produced.

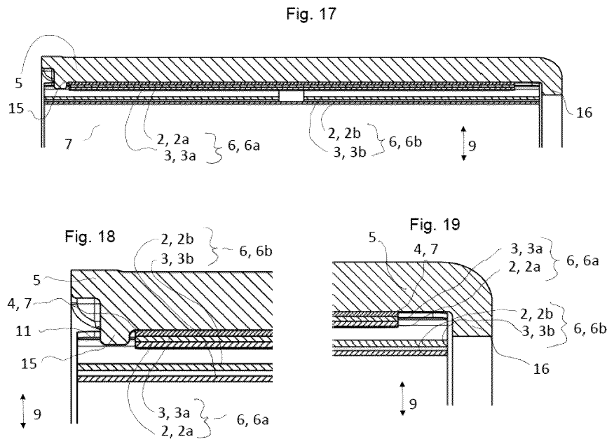

FIG. 17 shows a section in the axial direction 8 through the embodiment according to FIG. 15. Clearly visible in FIG. 17 is the overlapping of two curved segments 6a and 6b or the foils 2a, 2b, 3a, and 3b thereof, which have already been adequately described in FIG. 7. The annular collar 16 running around in the circumferential direction 10 is also clearly visible as an alternative to the discrete formation of local material displacements 15 to form a stop here when the tubular base 7 is installed in the outer ring 5. A radial overlap of the annular collar 16 with the foils of the tubular base 7, at least in the thickness of the base foil 4, is already sufficient to block a degree of freedom of the tubular base 7 in an axial direction, since the curved segments 6a to 6c are welded to the base foil 4 are and are wrapped by the base foil 4.

FIG. 18 shows a detailed view of one axial end of the sectioned outer ring 5 according to FIG. 15. The material displacement 15 engages in the notch 11 and secures the tubular base 7 in the circumferential direction 10 and also in an axial direction 8. The material displacement 15 protrudes in the radial direction 9 into the notch 11.

FIG. 19 shows a detailed view of the other axial end of the sectioned outer ring 5 according to FIG. 15. The annular collar 16 secures the tubular base 7 only in an axial direction 8. A securing in the circumferential direction 10 is not provided.

### REFERENCE NUMERALS

1 Radial foil bearing
2 Top foil
2a First top foil
2b Second top foil
2c Third top foil
3 Corrugated foil
3a First corrugated foil
3b Second corrugated foil
3c Third corrugated foil
4 Base foil
5 Outer ring
6 Curved segment
6a First curved segment
6b Second curved segment
6c Third curved segment
7 Tubular base
8 Axial direction
9 Radial direction
10 Circumferential direction
11 Notch
12 Slot
13 Rounding
14 Chamfer
15 Material displacement
16 Ring collar
17 Weld

1. A radial foil bearing having at least one top foil and at least one corrugated foil, the top foil and the corrugated foil being constructed one on top of the other in a radial direction and these foils in the circumferential direction forming at least one curved segment of the radial foil bearing,
wherein:
a first curved segment, consisting of a first top foil and a first corrugated foil, which are firmly connected to one another at a common end, is present,
the first curved segment (a) is firmly disposed on a base foil,
a second curved segment consisting of a second top foil and a second corrugated foil, which are firmly connected to one another at a common end, is disposed on the base foil, wherein
the two curved segments are placed one after the other on this base foil, so that when the base foil is rolled up, a tubular base having the two curved segments is created and forms the radial foil bearing.

2. The radial foil bearing according to claim 1, wherein a third curved segment is formed with a third top foil and a third corrugated foil, and the three curved segments each consist of a top foil and a corrugated foil which are disposed on the base foil in succession so that when the base foil is rolled up, the tubular base having the three curved segments is created and forms the radial foil bearing.

3. The radial foil bearing according to claim 1, wherein the number of curved segments and their sequential arrangement on a base foil can be scaled.

4. The radial foil bearing according to claim 1, wherein after the base foil has been rolled up to form a tubular base having the curved segments, the tubular base has a peripherally closed shape, and the two ends of the base foil face one another.

5. The radial foil bearing according to claim 1, wherein, after the base foil has been rolled up to form a tubular base having the curved segments, one end of one curved segment is opposite the end of a subsequent curved segment.

6. The radial foil bearing according to claim 4, wherein the two ends of the base foil contact one another.

7. The radial foil bearing according to claim 4, wherein the two ends of the base foil are spaced apart from one another.

8. The radial foil bearing according to claim 4, wherein the top foil has a greater curved length than the corrugated foil, so that successive top foils, after rolling up the base foil, overlap to form the tubular base touching at the ends thereof in the radial direction.

9. The radial foil bearing according to claim 1, wherein the tubular base is inserted into an outer ring to form the radial foil bearing.

10. The radial foil bearing according to claim 9, wherein the outer ring is a separate component which, together with the tubular base, forms the radial foil bearing which can be inserted into a housing or the outer ring is formed by the housing itself, in which the tubular base can be used to form the radial foil bearing.

11. The radial foil bearing according to claim 9, wherein a degree of freedom in an axial direction of the tubular base placed in the outer ring is blocked.

12. The radial foil bearing according to claim 9, wherein a degree of freedom in a circumferential direction of the tubular base placed in the outer ring is blocked.

13. A radial foil bearing comprising:
a base foil;
a first top foil;
a first corrugated foil arranged radially on top of the first top foil and fixed to the first top foil at a first common end to form a first curved segment fixed to the base foil and extending in a circumferential direction;
a second top foil;
a second corrugated foil arranged radially on top of the second top foil and fixed to the second top foil at a second common end to form a second curved segment fixed to the base foil and extending in the circumferential direction; wherein:
the second curved segment is placed after the first curved segment on the base foil so that, when the base foil is rolled up, the first curved segment and the second curved segment form at least a portion of a tubular base.

14. The radial foil bearing of claim 13, further comprising:
a third top foil; and
a third corrugated foil arranged radially on top of the third top foil and fixed to the third top foil at a third common end to form a third curved segment fixed to the base foil and extending in a circumferential direction; wherein:
the third curved segment is placed after the second curved segment on the base foil so that, when the base foil is rolled up, the first curved segment, the second curved segment and the third curved segment form the tubular base.

15. The radial foil bearing of claim 13, wherein a number of curved segments and their sequential arrangement on the base foil can be scaled.

16. The radial foil bearing of claim 13, wherein, after the base foil has been rolled up to form the tubular base:
the tubular base has a peripherally closed shape; and
a first end of the first curved segment faces a second end of the second curved segment.

17. The radial foil bearing of claim 16, wherein the first end contacts the second end.

18. The radial foil bearing of claim 16, wherein the first end is spaced apart from the second end

19. The radial foil bearing of claim 13, wherein:
the first top foil has a greater curved length than the first corrugated foil;
the second top foil has a greater curved length than the second corrugated foil; and
the second top foil overlaps the first top foil when the base foil is rolled up to form the tubular base.

20. The radial foil bearing of claim 13 further comprising an outer ring, wherein the tubular base is inserted into the outer ring.
